(19) United States
(12) Patent Application Publication
(10) Pub. No.: US 2004/0213638 A1
(43) Pub. Date: Oct. 28, 2004

(54) Cutting insert with thermal crack barrier

(76) Inventor: Nicholas F. Waggle JR., Derry, PA (US)

Correspondence Address: Larry R. Meenan, Kennametal Inc., P.O. Box 231, Latrobe, PA, 15650, US

(21) Appl. No.: 10/422,115

(22) Filed: Apr. 24, 2003

(51) Int. Cl. B23B 27/00

(52) U.S. Cl. 407/113

(57) ABSTRACT

A cutting insert has a rake surface, flank surface, and a cutting edge at the intersection of the rake surface and flank surface. A chip contact zone is located closely adjacent the cutting edge. The chip contact zone has a plurality of barriers therein for preventing propagation of thermal cracks in the cutting insert during use. The barriers having a width, angle, and/or length that prevents propagation of thermal cracks in a microscopic scale.

### FIELD OF THE INVENTION

The present invention relates to machine tools and, more particularly, to a removable cutting tool for use with a cutting tool holder. Most particularly, the present invention relates to a cutting insert having a barrier for reducing the effects of thermal or mechanical cracks at a microscopic scale.

### BACKGROUND OF THE INVENTION

A conventional cutting tool holder typically includes a plurality of pockets for receiving cutting inserts. Typical holders are in the form of boring bars, drills, and milling cutter. The inserts are generally made of carbide and come in numerous shapes. Cutting inserts include one or more cutting edges 44 formed between a rake surface 48 and a flank surface 46, as shown in FIGS. 6 and 7 of the prior art. The cutting edge 44 can be prepared with a sharp edge, a honed edge, or a T-land edge, which can be sharp or honed. A tool chip contact zone 50 can be formed in the rake surface 48 along the cutting edge 44 of the insert.

It is believed that excessive cycling effects of extremely high cutting temperatures followed by sudden cooling of the chip contact zone 50, as the insert emerges from a cut, causes thermal cracks 52. The sudden cooling of the insert causes an outer surface of the insert to contract quickly while a heated area just below the outer surface is contracting or cooling at a slower rate. This difference in contraction rate relative to the temperature gradient (i.e., the rate of change of temperature with displacement in a given direction from a given reference point) causes extreme stress within a very small region of the outer surface of the insert. The stress is usually relieved in the form of small thermal cracks 52 in the outer surface of the insert. The average point of nucleation of a thermal crack 52 is about 0.008 inch from the cutting edge 44. The thermal cracks 52 initiate almost perpendicularly to the cutting edge 44 of the insert along a line X that is generally parallel to the cutting edge 44 at the theoretically hottest point on the chip contact area 50 on the rake surface 48. This point varies slightly with cutting conditions, the insert geometry, and the workpiece material. Thermal cracks 52 have been observed to follow a path of least resistance, along pre-existing thermal cracks in a coating on the insert, if present, and around the grain structure of the carbide in irregular angles δ (i.e., about 83 to 96 degrees) but approximately 93 degrees to the cutting insert. Most thermal cracks 52 form at angles greater than 90 degrees but less than the micro-chipflow angle (i.e. chip flow in the chip contact zone). The micro-chipflow angle has been measured optically by flank surface wear scar at about 107 degrees. The thermal crack 52 grows in length toward the cutting edge 48 faster than in depth, width, and length away from the cutting edge 48. The insert usually fails abruptly when the crack 52 reaches the cutting edge 48, as shown in FIG. 6. The cause of failure is typically as a result of chipping and/or increased edge wear at the point where the thermal crack 52 breaks through the rake surface 48. A thermal crack breakout in the flank surface 46 is shown at 54 in FIG. 7.

It is desirable in the machine tool art to be able to reduce or delay thermal crack propagation growth to the cutting edge by disrupting the flow of the crack with a premature breakout before reaching the cutting edge. This would result in a longer life for the insert.

### SUMMARY OF THE INVENTION

Generally speaking, the invention is directed to a cutting insert having a rake surface, flank surface, and a cutting edge at the intersection of the rake surface and flank surface. A chip contact zone is located closely adjacent the cutting edge. The chip contact zone has a plurality of barriers therein for preventing or delaying the propagation of thermal cracks in the cutting insert from breakout (reaching the cutting edge) during use. The barriers have a width, angle or shape, length, and sufficient depth to desirably, or beneficially effect propagation of thermal cracks on a microscopic scale. The barriers disrupt or alter the path of thermal cracks. That is to say, cracks formed close enough to a barrier will be drawn toward the barrier rather than the cutting edge. Consequently, the barriers obstruct the propagation of the thermal cracks by premature breakout into the barrier.

### BRIEF DESCRIPTION OF THE DRAWINGS

FIG. 1 is a front elevational view of a milling cutter;

FIG. 2 is a side elevational view of a milling cutter similar to that shown in FIG. 1;

FIG. 3 is an enlarged partial side elevational view of a cutting insert;

FIG. 4 is an enlarged partial top plan view of a cutting insert rake surface having a thermal crack barrier thereon;

FIG. 5 is an enlarged partial top perspective view of the cutting insert illustrated in FIG. 4;

FIG. 6 is a top plan view of a PRIOR ART cutting insert; and

FIG. 7 is a side elevational view the cutting insert illustrated in FIG. 6.

### DETAILED DESCRIPTION OF THE INVENTION

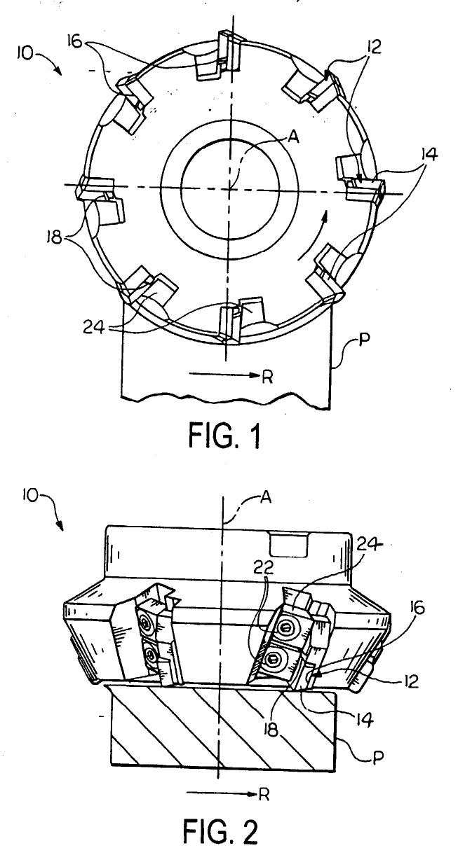

With reference now to the drawings, wherein like numerals designate like components throughout all of the several figures, there is illustrated in FIGS. 1 and 2 a cutter body, as generally indicated at 10. The cutter body 10 is adapted to be mounted to the spindle of a milling machine (not shown) and rotated about a rotary axis A in a counter-clockwise direction, indicated by the directional arrow shown in FIG. 1, to cut a workpiece, generally indicated at W.

The cutter body 10 comprises a plurality of pockets 12 formed in an outer periphery of a forward portion thereof. The pockets 12 are preferably arranged circumferentially in an equidistantly spaced relation to each other. Each pocket 12 is provided for receiving a cutting insert 14. It should be appreciated that the cutting inserts 12 are adapted for use with other machine tools, including but not limited to a boring bar or a drill.

Each pocket 12 comprises a substantially planar seat or base 16 and two shoulders (only one shoulder 18 being visible). The shoulders are substantially perpendicular to each other. Each shoulder provides a surface that abuts a corresponding surface of the cutting insert 14. A threaded bore (not shown) is provided in the vicinity of each pocket 12 for receiving a fastening screw 22 for forcing a wedge 24 against the cutting insert 14. This, in turn, forces the cutting insert 14 towards the base 16 and shoulders of the pocket 12 via the head of the fastening screw 22. Consequently, the cutting insert 14 is attached to the cutter body 10 in a detachable or removable manner.

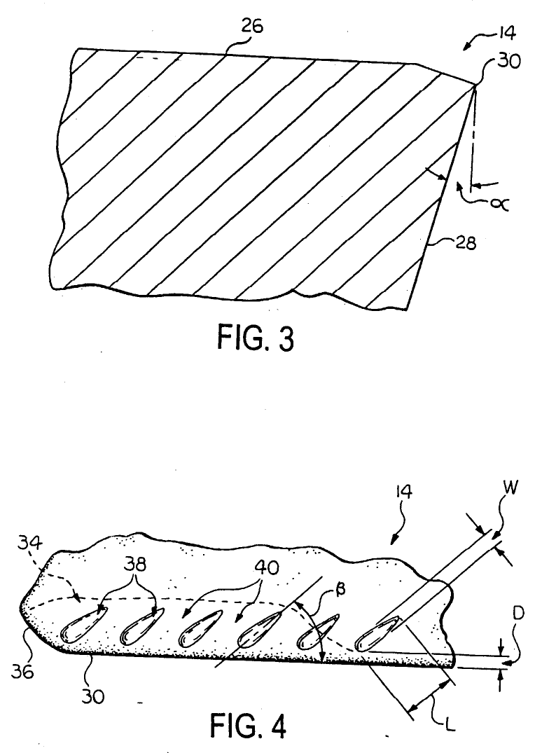

The cutting insert 14 may be any suitable polygonal shape, including but not limited to a generally triangular, rectangular, square, octagonal, hexagonal, or rhombic shape. An essential feature common to each of these shapes is that at least two sides or surfaces operatively join or intersect to form a corner or cutting edge. As shown in FIG. 3, the cutting insert 14 has rake surface 26, a clearance or flank surface 28, and a cutting edge 30 formed at the intersection of the rake surface 28 and the flank surface 30. Although only one cutting edge 30 is shown, it should be appreciated that a plurality of flank surfaces could form a plurality of cutting edges. For example, a triangular shaped cutting insert could have three cutting edges, a rectangular or square shaped cutting insert could have four cutting edges, etc. Adjacent cutting edges form a wiper facet or nose 36.

The cutting insert 14 shown is a positive cutting insert in which the rake surface 26 intersects the flank surface 28 at an acute angle and thus forms a clearance angle α. However, it is within the scope of the invention that the cutting insert could be a negative cutting insert, wherein the rake surface and the flank surface intersect perpendicularly and thus forms no clearance angle. The cutting edge 30 can be prepared with a sharp edge, a honed edge, or a T-land edge, which can be sharp or honed. For example, the cutting edge 30 shown in FIG. 3 is a sharp T-land cutting edge. The term sharp here can include cutting edges that are intentionally rounded to have a slight radius.

In operation, the cutter body 10 is rotated about the rotary axis A and the cutting edge 30 is caused to cut the workpiece P. As the cutter body 10 rotates, it also moves laterally or radially in a direction R (i.e., to the right when viewing FIGS. 1 and 2) perpendicular to the axis of rotation A to further cut the workpiece P. As the workpiece P is cut, chipping occurs, wherein chips are formed from material removed from the workpiece P.

The cutting insert 14 has a chip contact zone, generally indicated in the zone 34 within the broken line, located near the cutting edge 30 where the cutting insert 14 interfaces the workpiece P. The chip contact zone 34 has a geometric typography design or features that are centered at a point of thermal crack initiation. The features are angular, or otherwise obstructive to the path of propagation of the crack, toward the cutting edge. The geometric features are in the form of thermal crack barriers 38.

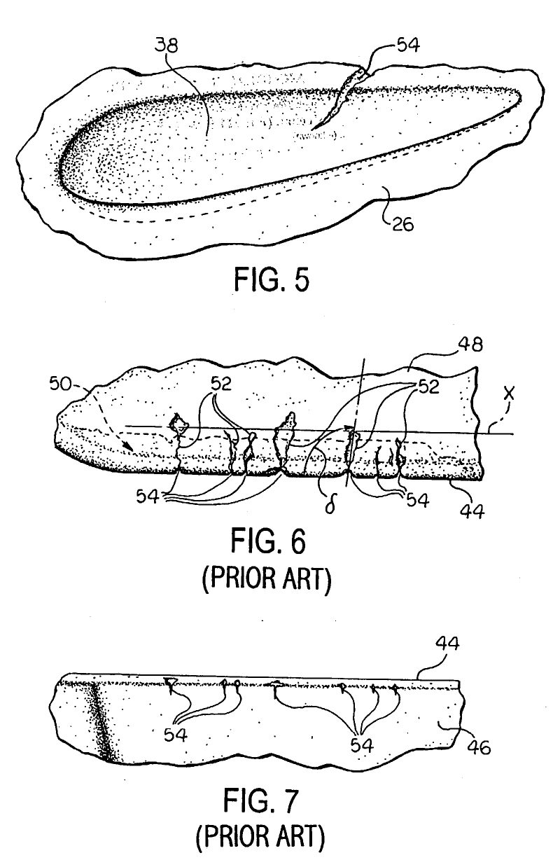

As illustrated in FIG. 4, a series of small rounded thermal crack barriers 38 are provided on the rake surface 26. Although ridges 40 are defined between the barriers 38, the transition between the barrier 38 and the rake surface 26 is rounded so that the barriers 38 do not form sharp edges (as illustrated in FIG. 5). The barriers 38 can be formed by pressing or grinding the cutting insert 14. Pressing is preferred because it is the most cost effective method. However, other means of production may be suitable for carrying out the invention.

The barriers 38 preferably originate a distance D (i.e., edge-to-barrier distance) in a range of about 0.002 inch to about 0.007 inch, and most preferably about 0.003 inch, from the cutting edge 30, for a cutting insert having, for example, a ½ inch inscribed circle (IC), and depending on the application of the insert 14. The edge-to-barrier distance D may need to be increased to avoid encroachment with edge preparation (i.e., a hone or a T-land) that may be employed. The barriers 38 are elongated and, in the illustrated embodiment of the invention, preferably have various depths that diminish (as is clearly illustrated in FIG. 5) farthest from the cutting edge 30 (i.e., an upper end of the barriers 38 when viewing FIG. 3) or increase toward the cutting edge 30.

The barriers 38 are oriented at an angle β relative to the cutting edge 30 and away from the nose 36 of the insert 14 (i.e., upward and to the right when viewing FIG. 3). According to a preferred embodiment of the invention, the angle β can be in a range of about 15 degrees to about 44 degrees. The angle is limited by a combination of factors that include the barrier width and the desired chip contact to barrier ratio. Changes in barrier shape and or width can be used to maintain the desired chip contact to barrier ratio.

The barriers 38 have micro-geometry features, which are much smaller than the geometry of conventional cutting inserts. For example, the width W of the barriers 38 can be in a range of about 0.001 inch to about 0.010 inch, for example, for a ½ inch inscribed circle (IC). The length L of the barriers 38 is preferably in a range of about 0.001 inch to about 0.080 inch, for the same insert, depending on the length L of the chip contact zone 34, and the barrier angle. Barriers set at an angle β of about 15 degrees would require a barrier length of about 0.077 inch to cover a typical 0.020 inch contact zone 34. The length L of the barriers 38 should be sufficiently long to cover the chip contact zone 34 (i.e., approximately 0.020 inch as measured perpendicularly relative to the cutting edge 30) but very small in relation to the cutting insert 14 and typography of a typical cutting insert. The spacing between the barriers 38 preferably reveals about 50 to 75 percent of the contact zone 34. Hence, the barriers 38 are preferably spaced equidistantly 1 to 1½ times the barrier width W. This is to achieve the desired chip contact to barrier ratio mentioned above.

The barriers 38 delay the propagation of cracks from the point of the crack nucleation, which is about 0.008 from the cutting edge 30, depending on the grade, workpiece material, and cutting condition. Thermal crack barrier features can be as small as 0.001 inch in size. The initial thermal cracks formed in the coating are even smaller. The intent is to address thermal crack propagation on a microscopic scale. Conventional cutting inserts fail to address crack propagation on a microscopic scale.

The depth, shape, width, and spacing of the barriers 38 depend on the desired chip contact to barrier ratio. All the features of the barriers 38 require rounded, blended, or smoothed transitions. The features can repeat from the wiper facet or nose 36 tangent point back along the cutting edge 30 of the rake surface 20. In a preferred embodiment of the invention, the barriers 38 have a steep drop off, as illustrated in FIG. 5, along a side of the barriers 38 closest to the cutting edge 30. The opposite side of each barrier 38 sweeps out at a less abrupt angle to reduce the risk of workpiece material buildup in the barrier 38. The barrier width-to-depth ratio is preferably limited to a range that prevents chips from contacting the bottom of the barrier 36, especially at a point that is a distance of about 0.008 inch from the cutting edge 30.

By applying the teachings of the present invention, propagation of thermal cracks in the cutting insert are prevented on a microscopic scale, chipping and/or increased edge wear of the cutting insert is reduced, and the useful life of the insert is extended.

While this invention has been described with respect to several preferred embodiments, various modifications and additions will become apparent to persons of ordinary skill in the art. All such variations, modifications, and variations are intended to be encompassed within the scope of this patent, which is limited only by the claims appended hereto.

What is claimed is:

1. A cutting insert comprising:
a rake surface;
a flank surface;
a cutting edge at the intersection of the rake surface and flank surface, the cutting edge terminating at a nose; and
a chip contact zone located closely adjacent the cutting edge, the zone having a plurality of barriers therein for preventing propagation of thermal cracks in the cutting insert during use, the barriers having a width in a range of about 0.001 inch to about 0.010 inch.

2. The insert of claim 1, wherein the width is about 0.008 inch.

3. The insert of claim 1, wherein the barriers are oriented at an angle in a range of about 15 degrees to about 44 degrees relative to the cutting edge.

4. The insert of claim 1, wherein the barriers have a length in a range of about 0.001 inch to about 0.080 inch.

5. The insert of claim 1, wherein the barriers are oriented at an angle in a range of about 15 degrees and have a length that is about 0.077 inch.

6. The insert of claim 1, wherein the barriers are oriented at an angle in a range of about 40 degrees and have a length that is about 0.030 inch.

7. In combination:
a cutting tool holder having one or more pockets; and
a cutting insert received in each one of the one or more pockets, the cutting insert comprising:
a rake surface;
a flank surface;
a cutting edge at the intersection of the rake surface and flank surface; and
a chip contact zone located closely adjacent the cutting edge, the zone having a plurality of barriers therein for preventing propagation of thermal cracks in the cutting insert during use, the barriers being oriented at an angle in a range of about 15 degrees to about 44 degrees relative to the cutting edge.

8. The insert of claim 7, wherein the barriers have a width in a range of about 0.001 inch to about 0.010 inch.

9. The insert of claim 7, wherein the barriers have a width that is about 0.008 inch.

10. The insert of claim 7, wherein the barriers have a length in a range of about 0.001 inch to about 0.080 inch.

11. The insert of claim 7, wherein the barriers are oriented at an angle in a range of about 15 degrees and have a length that is about 0.077 inch.

12. The insert of claim 7, wherein the barriers are oriented at an angle in a range of about 40 degrees and have a length that is about 0.030 inch.

13. In combination:
a cutting tool holder having one or more pockets; and
a cutting insert received in each one of the one or more pockets, the cutting insert comprising:
a rake surface;
a flank surface;
a cutting edge at the intersection of the rake surface and flank surface and terminating in a nose; and
a chip contact zone located closely adjacent the cutting edge, the zone having a plurality of barriers therein for preventing propagation of thermal cracks in the cutting insert during use, the barriers having a length in a range of about 0.001 inch to about 0.080 inch.

14. The insert of claim 13, wherein the barriers have a width in a range of about 0.001 inch to about 0.010 inch.

15. The insert of claim 13, wherein barriers have a width that is about 0.008 inch.

16. The insert of claim 13, wherein the barriers are oriented at an angle in a range of about 15 degrees to about 44 degrees relative to the cutting edge.

17. The insert of claim 13, wherein the barriers are oriented at an angle in a range of about 15 degrees and the length is about 0.077 inch.

18. The insert of claim 13, wherein the barriers are oriented at an angle in a range of about 40 degrees and have the length is about 0.030 inch.

19. In combination:
a cutting tool holder having one or more pockets; and
a cutting insert received in each one of the one or more pockets, the cutting insert comprising:
a rake surface;
a flank surface;
a cutting edge at the intersection of the rake surface and flank surface and terminating in a nose; and
a chip contact zone located closely adjacent the cutting edge, the zone having a plurality of barriers therein for interfering propagation of thermal cracks in the cutting insert during use.
